(19) United States
(12) Patent Application Publication
(10) Pub. No.: US 2013/0052533 A1
(43) Pub. Date: Feb. 28, 2013

(54) NEGATIVE ACTIVE MATERIAL FOR LITHIUM SECONDARY BATTERY AND LITHIUM SECONDARY BATTERY INCLUDING THE SAME

(71) Applicants: Hee-Joon Chun, Yongin-si (KR); Tae-Gon Kim, Yongin-si (KR); Joon-Sup Kim, Yongin-si (KR); Wan-Uk Choi, Yongin-si (KR); Tarui Hisaki, Yongin-si (KR); Jea-Woan Lee, Yongin-si (KR); Jae-Yul Ryu, Yongin-si (KR); Chang-Keun Back, Yongin-si (KR); Young-Chang Lim, Yongin-si (KR); Seung-Hee Park, Yongin-si (KR)

(72) Inventors: Hee-Joon Chun, Yongin-si (KR); Tae-Gon Kim, Yongin-si (KR); Joon-Sup Kim, Yongin-si (KR); Wan-Uk Choi, Yongin-si (KR); Tarui Hisaki, Yongin-si (KR); Jea-Woan Lee, Yongin-si (KR); Jae-Yul Ryu, Yongin-si (KR); Chang-Keun Back, Yongin-si (KR); Young-Chang Lim, Yongin-si (KR); Seung-Hee Park, Yongin-si (KR)

(73) Assignee: Samsung SDI Co., Ltd., Yongin-si (KR)

(21) Appl. No.: 13/369,141

(22) Filed: Feb. 8, 2012

(30) Foreign Application Priority Data
Aug. 31, 2011 (KR) 10-2011-0087810

(51) Int. Cl. H01M 4/134

(52) U.S. Cl. 429/218.1; 252/182.1

(57) ABSTRACT

In one aspect, a negative active material for a lithium secondary battery including silicon oxide represented by a chemical formula SiOₓ (1.1<x<1.5) and a negative electrode and a lithium secondary battery including the negative active material is provided. The silicon oxide may be amorphous silicon oxide.

### CROSS-REFERENCE TO RELATED APPLICATIONS

This application claims priority to and the benefit of Korean Patent Application No. 10-2011-0087810 filed on Aug. 31, 2011 in the Korean Intellectual Property Office, the disclosure of which is incorporated in its entirety herein by reference.

### BACKGROUND

1. Field

This disclosure relates to a negative active material for a lithium secondary battery and a lithium secondary battery including the same.

2. Description of the Related Technology

Batteries transform stored chemical energy into electrical energy. Such batteries include a primary battery, which are designed to be disposed of after the energy of the battery is consumed, and a rechargeable battery, which are designed to be recharged many times.

The rechargeable battery can be charged/discharged many times under appropriate conditions.

Recent developments in high-tech electronics has allowed electronic devices to become small and light in weight, which allows these devices to be portable electronic devices. Batteries with high energy density are a desirable power source for such portable electronic devices.

A lithium secondary battery may be fabricated by injecting electrolyte into a battery cell, which includes a positive electrode including a positive active material capable of intercalating/deintercalating lithium ions and a negative electrode including a negative active material capable of intercalating/deintercalating lithium ions. Various carbon-based materials such as artificial graphite, natural graphite, and hard carbon, which can all intercalate and deintercalate lithium ions, have been used for negative active materials. However, carbon-based material may sometimes have a side reaction with an electrolyte at a high discharge voltage and thus, may have undesirable consequences due to misoperation and overcharge of a lithium secondary battery. To address certain undesirable consequences that may arise from using carbon-based material, an oxide negative active material has recently been developed as a negative active material.

The oxide negative active material may, for example, include a silicon oxide-based negative active material. The silicon oxide-based negative active material may have high capacity and excellent cycle-life characteristics. However, the silicon oxide-based negative active material has a crystal structure change when lithium ions are intercalated and deintercalated and thus, may have a volume expansion. This volume expansion may cause a breakup of an active material particle and deteriorating battery performance.

### SUMMARY

One embodiment of this disclosure provides a negative active material for a lithium secondary battery preventing volume expansion of a lithium secondary battery and improving its performance.

Another embodiment of this disclosure provides a lithium secondary battery including the negative active material.

According to one embodiment, provided is a negative active material for a lithium secondary battery including silicon oxide represented by a chemical formula SiOₓ (1.1<x<1.5). In certain embodiments, the silicon oxide may be amorphous silicon oxide.

In certain embodiments, the value of x may be in a range of 1.25 to 1.35.

In certain embodiments, silicon oxide may have a first peak in a region ranging from about 150 cm⁻¹ to 200 cm⁻¹ and a second peak in a region ranging from about 450 cm⁻¹ to 500 cm⁻¹, and the first and second peaks have a ratio ranging from about 1:1.5 to about 1:2.5 in the Raman spectroscopy. In certain embodiments, the silicon oxide may be amorphous silicon oxide.

In certain embodiments, first and second peaks may have a ratio ranging from about 1:1.8 to about 1:2.35.

In certain embodiments, silicon oxide may have a cumulative 90% diameter (D90) of about 50 μm or less in a diameter distribution obtained in a laser diffraction scattering diameter distribution method. In certain embodiments, the silicon oxide may be amorphous silicon oxide.

In certain embodiments, silicon oxide may have a cumulative 90% diameter (D90) ranging from about 0.5 μm to about 40 μm in a diameter distribution obtained in a laser diffraction scattering diameter distribution method. In certain embodiments, the silicon oxide may be amorphous silicon oxide.

In certain embodiments, negative active material may further include crystalline silicon oxide. In certain embodiments, the crystalline silicon may have a size ranging from about 1 nm to about 800 nm.

According to another embodiment of the this disclosure, a negative electrode for a lithium secondary battery including a current collector and an active material layer disposed on the current collector and including a negative active material, wherein the negative active material includes silicon oxide represented by a chemical formula SiOₓ (1.1<x<1.5) is provided. In certain embodiments, the silicon oxide may be amorphous silicon oxide. In certain embodiments, the value of x may be in a range of 1.25 to 1.35. In certain embodiments, silicon oxide may have a first peak in a region ranging from about 150 cm⁻¹ to 200 cm⁻¹ and a second peak in a region ranging from about 450 cm⁻¹ to 500 cm⁻¹, and the first and second peaks have a ratio ranging from about 1:1.5 to about 1:2.5 in the Raman spectroscopy. In certain embodiments, first and second peaks may have a ratio ranging from about 1:1.8 to about 1:2.35. In certain embodiments, silicon oxide may have a cumulative 90% diameter (D90) of about 50 μm or less in a diameter distribution obtained in a laser diffraction scattering diameter distribution method. In certain embodiments, silicon oxide may have a cumulative 90% diameter (D90) ranging from about 0.5 μm to about 40 μm in a diameter distribution obtained in a laser diffraction scattering diameter distribution method. In certain embodiments, negative active material may further include crystalline silicon oxide. In certain embodiments, the crystalline silicon may have a size ranging from about 1 nm to about 800 nm.

According to yet another embodiment of this disclosure a lithium secondary battery including the negative electrode as disclosed herein is provided. In certain embodiments, the lithium secondary battery further comprises a positive electrode; and a separator, wherein the separator is interposed between the negative electrode and the positive electrode.

In certain embodiments, the negative active material may have no volume expansion during the charge and discharge and may improve efficiency and cycle-life characteristic of a battery.

### BRIEF DESCRIPTION OF THE DRAWING

FIG. 1 is a schematic view showing a lithium secondary battery according to one embodiment.

### DETAILED DESCRIPTION

Exemplary embodiments will hereinafter be described in detail. However, these embodiments are only exemplary, and the present invention this disclosure is not limited thereto.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Hereinafter, a negative active material for a lithium secondary battery according to one embodiment of the present disclosure is illustrated.

In certain embodiments, a negative active material for a lithium secondary battery may include amorphous silicon oxide represented by a chemical formula SiOₓ (1.1<x<1.5).

In certain embodiments, the amorphous silicon oxide has an amorphous state in which silicon (Si) and oxygen (O) are disorderly arranged. In certain embodiments, the negative active material may have no volume expansion during the charge and discharge.

In the above formula, x indicates a ratio of an oxygen atom (O) relative to a silicon atom (Si) and is in a range of 1.1<x<1.5. In certain embodiments, the value of x may be measured by using X-ray fluorescent spectroscopy (XRF). When the range is converted into a weight ratio, oxygen may be included in an amount ranging from about 38.55 wt % to about 46.10 wt % based on the amount of amorphous silicon oxide.

In certain embodiments, the oxygen atoms may buffer during the charge and discharge of a lithium secondary battery when oxygen is included in amorphous silicon oxide within the range. Thus, preventing sharp expansion of amorphous silicon oxide and simultaneously, securing the amount of silicon in the amorphous silicon oxide and improving charge and discharge capacity and efficiency of a battery.

In certain embodiments, the value of x may be in a range of 1.25<x<1.35. Oxygen may be included in an amount ranging from about 41.61 wt % to about 43.50 wt % based on the amount of amorphous silicon oxide when the value of x is converted into a weight ratio.

In certain embodiments, the amorphous silicon oxide may have a first peak in a region ranging from about 150 cm⁻¹ to about 200 cm⁻¹ and a second peak in a region ranging from about 450 cm⁻¹ to about 500 cm⁻¹ in the Raman spectrum.

In certain embodiments, the first and second peaks indicate amorphous degrees of silicon oxide and may have a height ratio ranging from about 1:1.5 to about 1:2.5. The ratio of the first and second peaks indicates height intensity.

In certain embodiments, the silicon and oxygen are uniformly distributed in an amorphous silicon oxide and may suppress initial non-reversible reaction of a battery and its charge and discharge capacity and cycle-life when the first and second peaks have a ratio within the range.

In certain embodiments, the first peak and second peaks may have a height ratio ranging from about 1:1.8 to about 1:2.35.

In certain embodiments, the amorphous silicon oxide may have a cumulative 90% diameter (D90) of about 50 μm or less in the diameter distribution acquired in a laser diffraction scattering diameter distribution method and may have a diameter ranging from about 0.5 μm to 40 μm. In certain embodiments, a specific surface area may be maintained when the amorphous silicon oxide has a diameter within the range.

In certain embodiments, the negative active material may further include crystalline silicon other than the amorphous silicon oxide. In certain embodiments, the crystalline silicon may have a size ranging from about 1 nm to about 800 nm. In a typical embodiment, the crystalline silicon may have a size ranging from about 1 nm to about 100 nm.

In certain embodiments, the negative active material may include amorphous silicon oxide including oxygen within a predetermined range and thus, may prevent volume expansion of an active material during the charge and discharge of a lithium secondary battery and decrease crack generation of the active material layer and improve efficiency and cycle-life characteristic of a lithium secondary battery.

Hereinafter, a negative electrode for a lithium secondary battery including the aforementioned negative active material is illustrated.

In certain embodiments, the negative electrode for a lithium secondary battery may include a current collector and a negative active material layer disposed on the current collector.

In certain embodiments, the current collector may include a copper foil, a nickel foil, a stainless steel foil, a titanium foil, a nickel foam, a polymer substrate coated with conductive metals, and the like, but is not limited thereto.

In certain embodiments, the negative active material layer may include a negative active material, a binder, and optionally a conductive material.

In certain embodiments, the negative active material may be a material that reversibly intercalates/deintercalates lithium ions and includes amorphous silicon oxide represented by a chemical formula SiOₓ (1.1<x<1.5). In certain embodiments, the negative active material may be amorphous silicon oxide represented by a chemical formula SiOₓ (1.1<x<1.5).

In certain embodiments, the negative active material may be included in an amount of about 60 wt % to about 98 wt %. Negative active material included within the range may improve capacity.

In certain embodiments, the binder may improve binding properties of the negative active material particles to one another and to a current collector. Examples of the binder include, but are not limited to, polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like.

In certain embodiments, the binder may be included in an amount of about 1 wt % to about 20 wt %. In certain embodiments, the binder may be included in an amount of from about 2 wt % to about 10 wt % based on the entire amount of a negative active material layer. Binder included within the range may secure sufficient adherence and not deteriorate capacity.

In certain embodiments, conductive material may be included to improve electrical conductivity of a negative electrode. Any electrically conductive material can be used as a conductive agent that does not cause a chemical change. Examples of the conductive material include, but are not limited to, a carbon-based material such as natural graphite, artificial graphite, carbon black, acetylene black, ketjen black, a carbon fiber, and the like; a metal-based material of a metal powder or metal fiber of copper, nickel, aluminum, silver, and the like; a conductive polymer such as a polyphenylene derivative; or a mixture thereof.

In certain embodiments, the conductive material may be included in an amount of about 1 to about 20 wt %. In certain embodiments, the conductive material may be included in an amount of from about 1 wt % to about 10 wt % based on the entire amount of a negative active material layer. Conductive material included within the range may secure capacity and improve conductivity.

In certain embodiments, the negative electrode may be fabricated by a method including mixing the negative active material, and a binder and optionally a conductive material to provide an active material slurry, and coating the slurry on a current collector. In certain embodiments, the solvent may include N-methylpyrrolidone, dimethylformamide and the like, but is not limited thereto.

In certain embodiments, the negative electrode may be applied to a lithium secondary battery.

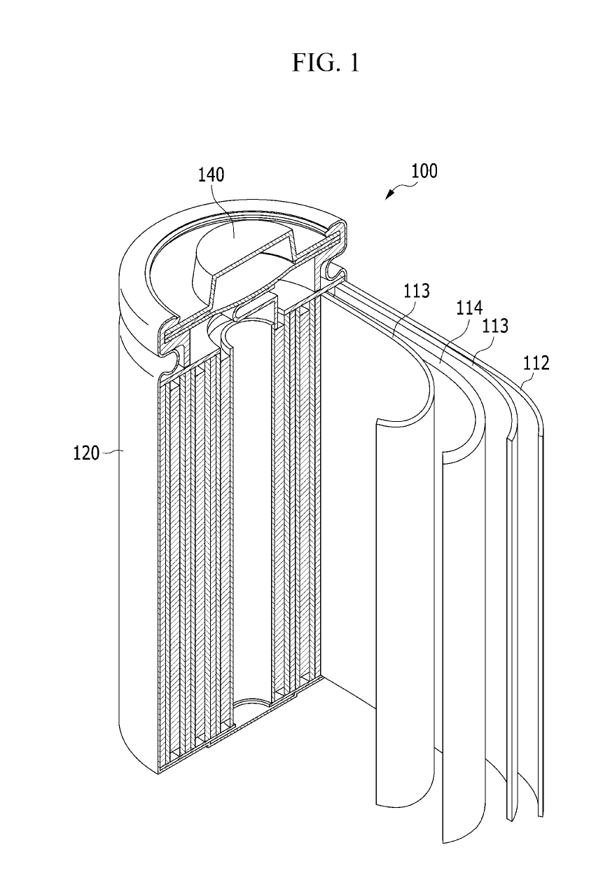

FIG. 1 is a schematic view of a lithium secondary battery according to one embodiment.

Referring to FIG. 1, a lithium secondary battery 100 includes an electrode assembly including a negative electrode 112, a positive electrode 114, a separator 113 interposed between the negative electrode 112 and the positive electrode 114, and an electrolyte (not shown) impregnated the negative electrode 112, positive electrode 114, and separator 113, a battery case 120 including the battery cell, and a sealing member sealing the battery case 120.

In certain embodiments, the negative electrode 112 may be the same as described above.

In certain embodiments, the positive electrode 114 may include a current collector and a positive active material layer disposed on the current collector.

In certain embodiments, the current collector may be an aluminum foil, but is not limited thereto.

In certain embodiments, the positive active material layer may include a positive active material, a binder, and optionally a conductive material.

In certain embodiments, the positive active material may include any compounds that reversibly intercalate and deintercalate lithium ions. In certain embodiments, the positive active material may include, a composite oxide including at least one selected from cobalt (Co), manganese (Mn), nickel (Ni), and a combination thereof, as well as lithium (Li)

In certain embodiments, the compound may include, for example LiₐA_{1-b}D_{b}E₂ (0.90≦a≦1.8, and 0≦b≦0.5); LiₐG_{1-b}D_{b}O_{2-c}J_{c} (0.90≦a≦1.8, 0≦b≦0.5, and 0≦c≦0.05); LiG_{2-b}D_{b}O_{4-c}J_{c} (0≦b≦0.5, and 0≦c≦0.05); LiₐNi_{1-b-c}Co_{b}D_{c}E_{α} (0.90≦a≦1.8, 0≦b≦0.5, 0≦c≦0.05, and 0<α≦2); LiₐNi_{1-b-c}Co_{b}D_{c}O_{2-α}J_{α} (0.90≦a≦1.8, 0≦b≦0.5, 0≦c≦0.05, and 0≦α≦2); LiₐNi_{1-b-c}Co_{b}D_{c}O_{2-α}J₂ (0.90≦a≦1.8, 0≦b≦0.5, 0≦c≦0.05, and 0<α<2); LiₐNi_{1-b-c}Mn_{b}D_{c}E_{α} (0.90≦a≦1.8, 0≦b≦0.5, 0≦c≦0.05, and 0<α2); LiₐNi_{1-b-c}Mn_{b}D_{c}O_{2-α}J_{α} (0.90≦a≦1.8, 0≦b≦0.5, 0≦c≦0.05, and 0<α<2); LiₐNi_{1-b-c}Mn_{b}D_{c}O_{2-α}J₂ (0.90≦a≦1.8, 0≦b≦0.5, 0≦c≦0.05, and 0<α≦2); LiₐNi_{b}G_{c}LₐO₂ (0.90≦a≦1.8, 0≦b≦0.9, 0≦c≦0.5, and 0.001≦d≦0.1); LiₐNi_{b}Co_{c}Mn_{d}LₑO₂ (0.90≦a≦1.8, 0≦b≦0.9, 0≦c≦0.5, 0≦d≦0.5, and 0.001≦e≦0.1); LiₐNiL_{b}O₂ (0.90≦a≦1.8, and 0.001≦b≦0.1); LiₐCoL_{b}O₂ (0.90≦a≦1.8, and 0.001≦b≦0.1); LiₐMnL_{b}O₂ (0.90≦a≦1.8, and 0.001≦b≦0.1); LiₐMn₂L_{b}O₄ (0.90≦a≦1.8, and 0.001≦b≦0.1); QO₂; QS₂; LiQS₂; V₂O₅; LiV₂O₅; LiRO₂; LiNiVO₄; Li_{(3-f)}Z₂(PO₄)₃ (0≦f≦2); Li_{(3-f)}Fe₂(PO₄)₃ (0≦f≦2); and LiFePO₄.

In certain embodiments, A may be selected from the group consisting of Ni, Co, Mn, and combinations thereof; D may be selected from the group consisting of Al, Ni, Co, Mn, Cr, Fe, Mg, Sr, V, a rare earth element, and combinations thereof; E may be selected from the group consisting of O, F, S, P, and combinations thereof; G may be selected from the group consisting of Co, Mn, and combinations thereof; J may be selected from the group consisting of F, S, P, and combinations thereof; L may be selected from the group consisting of Al, Cr, Mn, Fe, Mg, La, Ce, Sr, V, and combinations thereof; Q may be selected from the group consisting of Ti, Mo, Mn, and combinations thereof; R may be selected from the group consisting of Cr, V, Fe, Sc, Y, and combinations thereof; and Z may be selected from the group consisting of V, Cr, Mn, Co, Ni, Cu, and combinations thereof.

In certain embodiments, the binder and conductive material may be the same as described above.

In certain embodiments, separator 113 separates a negative electrode 112 and a positive electrode 114 and provides a path for lithium ions and may include any separator commonly used in a lithium battery. For example, the separator may have low resistance against electrolyte ions and excellent moisturizing capability of an electrolyte solution. In certain embodiments, the separator may be a glass fiber, polyester, TEFLON (tetrafluoroethylne), polyethylene, polypropylene, polytetrafluoroethylene (PTFE), or a combination thereof and may have a non-woven fabric type or a fabric type. In certain embodiments, a polyolefin-based polymer separator such as polyethylene, polypropylene, and the like may be used for a lithium ion battery, a separator coated with a ceramic component or a polymer material may be used to secure heat resistance or mechanical strength. In certain embodiments, the separator may have a singular layer or multi-layers.

In certain embodiments, the electrolyte may include an organic solvent and a lithium salt. In certain embodiments, the organic solvent may be a non aqueous organic solvent. In certain embodiments, the electrolyte may include a non-aqueous organic solvent and a lithium salt.

In certain embodiments, the organic solvent may serve as a medium for transmitting ions taking part in the electrochemical reaction of the battery. In certain embodiments, the organic solvent may include a carbonate-based, ester-based, ether-based, ketone-based, alcohol-based, or aprotic solvent. Examples of the carbonate-based solvent include, but are not limited to, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. Examples of the ester-based solvent include, but are not limited to, methyl acetate, ethyl acetate, n-propyl acetate, dimethylacetate, methylpropionate, ethylpropionate, γ-butyrolactone, decanolide, valerolactone, DL-mevalonolactone, caprolactone, and the like. Examples of the ether include, but are not limited to, dibutyl ether, tetraglyme, diglyme, dimethoxyethane, 2-methyltetrahydrofuran, tetrahydrofuran, and the like, and examples of the ketone-based solvent include, but are not limited to, cyclohexanone, and the like. In certain embodiments, the alcohol-based solvent may include ethanol, isopropyl alcohol, and the like, and the aprotic solvent include but is not limited to, nitriles of X—CN (wherein X is C2 to C20 linear, branched, or cyclic hydrocarbon group, or includes an aromatic ring, or an ether); amides such as dimethyl formamide, dioxolanes such as 1,3-dioxolane; sulfolanes, and the like.

In certain embodiments, the organic solvent may be used singularly or in a mixture. When the organic solvent is used in a mixture, the mixture ratio can be controlled in accordance with desirable battery performance as understood by a person skilled in the art.

In certain embodiments, the lithium salt in the organic solvent supplies lithium ions in the battery, and improves lithium ion transport between positive and negative electrodes.

In certain embodiments, the lithium salt may be selected from LiPF₆, LiBF₄, LiSbF₆, LiAsF₆, LiClO₄, LiCF₃SO₃, LiC₄F₉SO₃, LiN(CF₃SO₂)₂, LiN(C₂F₅SO₂)₂, LiAlO₂, LiAlCl₄, LiN(CₚF₂ₚ₊₁SO₂)(C_{q}F_{2q+1}SO₂) wherein, p and q are natural number, LiCl, LiI, lithium bisoxalate borate, and a mixture thereof.

In certain embodiments, the lithium salt may be used at a concentration ranging from about 0.1 M to about 2.0M. In certain embodiments, the lithium salt may be used at a concentration ranging from about 0.7M to about 1.6 M. In certain embodiments, the lithium salt within the above range may maintain suitable viscosity of an electrolyte so that the electrolyte performance may be suitably maintained and the mobility of lithium ions may be suitably maintained.

Hereinafter, examples of one or more embodiments will be described in more detail including comparative examples. However, these examples are not intended to limit the scope of the one or more embodiments.

### Preparation of Negative Active Material

### Preparation Example 1

A negative active material represented by a chemical formula SiO_{1.14} (39.40 wt % of oxygen, D90: 11.6 μm) was prepared by respectively disposing a Si target and a SiO target in a reactor and then, supplying Si and SiO₂ in a mole ratio of 1:1.4 on a substrate. Herein, the reactor was maintained under a normal pressure and an argon gas atmosphere.

### Preparation Example 2

A negative active material was prepared according to Preparation Example 1 except for preparing a negative active material represented by a chemical formula SiO_{1.27} (42.00 wt % of oxygen, D90: 12.2 μm) by supplying Si and SiO₂ in a ratio of 1:1.6.

### Preparation Example 3

A negative active material was prepared according to Preparation Example 1 except for preparing a negative active material represented by a chemical formula SiO_{1.33} (43.13 wt % of oxygen, D90: 11.7 μm) by supplying Si and SiO₂ in a ratio of 1:1.8.

### Preparation Example 4

A negative active material was prepared according to Preparation Example 1 except for preparing a negative active material represented by a chemical formula SiO_{1.48} (45.77 wt % of oxygen, D90: 12.3 μm) by supplying Si and SiO₂ in a ratio of 1:2.0.

### Comparative Preparation Example 1

A negative active material was prepared according to Preparation Example 1 except for preparing a negative active material represented by a chemical formula SiO_{0.91} (34.16 wt % of oxygen, D90: 12.4 μm) by supplying Si and SiO₂ in a ratio of 1:0.8.

### Comparative Preparation Example 2

A negative active material was prepared according to Preparation Example 1 except for preparing a negative active material represented by a chemical formula SiO_{1.02} (36.77 wt % of oxygen, D90: 11.4 μm) by supplying Si and SiO₂ in a ratio of 1:1.0.

### Comparative Preparation Example 3

A negative active material was prepared according to Preparation Example 1 except for preparing a negative active material represented by a chemical formula SiO_{1.58} (47.39 wt % of oxygen, D90: 12.0 μm) by supplying Si and SiO₂ in a ratio of 1:2.2.

### Comparative Preparation Example 4

A negative active material was prepared according to Preparation Example 1 except for preparing a negative active material represented by a chemical formula SiO_{1.77} (50.23 wt % of oxygen, D90: 11.8 μm) by supplying Si and SiO₂ in a ratio of 1:2.6.

Raman Spectroscopy Analysis

The negative active materials according to Preparation Examples 1 to 4 and Comparative Preparation Examples 1 to 4 were analyzed by performing Raman Spectroscopy.

The Raman Spectroscopy analysis was performed by using a Raman spectrometer (Reishwa plc, InVia Raman microscope) and a charge coupled device camera (cooled at 140 K).

Referring to the Raman Spectroscopy analysis results, the negative active materials showed peaks at a region ranging from about 150 cm⁻¹ to 200 cm⁻¹ region and about 450 cm⁻¹ to 500 cm⁻¹. The first peak (A) ranging from about 150 cm⁻¹ to 200 cm⁻¹ and the second peak (B) ranging from about 450 cm⁻¹ to 500 cm⁻¹ have a ratio as provided in Table 1.

TABLE 1

| | Raman peak |
|---|---|
| | ratio (B/A) |
| Preparation Example 1 | 1.84 |
| Preparation Example 2 | 1.95 |
| Preparation Example 3 | 2.12 |
| Preparation Example 4 | 2.31 |
| Comparative Preparation Example 1 | 1.23 |
| Comparative Preparation Example 2 | 1.47 |
| Comparative Preparation Example 3 | 2.55 |
| Comparative Preparation Example 4 | 2.84 |

### Fabrication of Lithium Secondary Battery Cell

### Example 1

A negative active material slurry was prepared by combining 80 wt % of the negative active material according to Preparation Example 1, 10 wt % of Super P® (TIMCAL Ltd, Switzerland, conductive material), and 10 wt % of polytetrafluoroethylene (binder) in N-methylpyrrolidone solvent. The negative active material slurry was coated on a copper foil current collector, fabricating a negative electrode.

Next, a positive active material slurry was prepared by combining 96 wt % of a LMO(LiMn₂O₄)/NCM(LiNi_{0.3}Co_{0.3}Mn_{0.3}O₂) positive active material, 2 wt % of PVdF (polyvinylidene fluoride), and 2 wt % of a conductive material in N-methylpyrrolidone solvent. The positive active material slurry was coated on an aluminum foil current collector, fabricating a positive electrode.

A battery cell was fabricated using the negative and positive electrodes, a separator made of a polyethylene material film, and an electrolyte. An EC (ethylcarbonate)/EMC (ethylmethylcarbonate)/DMC (dimethylcarbonate) (2/2/6, v/v/v) electrolyte solution including 1.15M LiPF₆ was used as the electrolyte.

### Example 2

A cell was fabricated according to Example 1 except for using the negative active material of Preparation Example 2 instead of the negative active material of Preparation Example 1.

### Example 3

A battery cell was fabricated according to Example 1 except for using the negative active material of Preparation Example 3 instead of the negative active material of Preparation Example 1.

### Example 4

A battery cell was fabricated according to Example 1 except for using the negative active material of Preparation Example 4 instead of the negative active material of Preparation Example 1.

### Comparative Example 1

A battery cell was fabricated according to Example 1 except for using the negative active material of Comparative Preparation Example 1 instead of the negative active material of Preparation Example 1.

### Comparative Example 2

A battery cell was fabricated according to Example 1 except for using the negative active material of Comparative Preparation Example 2 instead of the negative active material of Preparation Example 1.

### Comparative Example 3

A battery cell was fabricated according to Example 1 except for using the negative active material of Comparative Preparation Example 3 instead of the negative active material of Preparation Example 1.

### Comparative Example 4

A battery cell was fabricated according to the same method as Example 1 except for using the negative active material of Comparative Preparation Example 4 instead of the negative active material of Preparation Example 1.

Evaluation-1

The battery cells according to Examples 1 to 4 and Comparative Examples 1 to 4 were once charged and then, evaluated regarding expansion degrees of a negative electrode and crack generation degrees on the surface thereof.

The charge was performed under a constant current condition of 0.05 C (cut-off 0.005V).

After the battery cells were once charged, a negative electrodes were separated therefrom and cleaned with dimethyl carbonate (DMC) and then, measured regarding thickness variation ratios (expansion ratio) relative to initial thickness.

The crack generation degrees were measured by observing the surface of a negative electrode with a scanning electron microscope (SEM) at 2500 magnifications. The crack generation ratio was calculated as the number of particles with a crack relative to the number of entire active material particles.

The results are provided in Table 2.

TABLE 2

| | Expansion ratio | Crack generation |
|---|---|---|
| | (%) | ratio (%) |
| Example 1 | 80.6 | 15.9 |
| Example 2 | 60.9 | 3.4 |
| Example 3 | 55.2 | 1.2 |
| Example 4 | 59.5 | 7.5 |
| Comparative Example 1 | 140.6 | 68.4 |
| Comparative Example 2 | 210.9 | 88.8 |
| Comparative Example 3 | 59.3 | 12.8 |
| Comparative Example 4 | 66.3 | 14.4 |

Referring to Table 2, the battery cells according to Examples 1 to 4 had low expansion degrees and crack generation degrees of a negative electrode after the charge and discharge, while the lithium secondary battery cells according to Comparative Examples 1 and 2 had high expansion degrees and crack generation degrees.

Evaluation-2

The battery cells according to Examples 1 to 4 and Comparative Examples 1 to 4 were evaluated regarding electrochemical characteristic.

The battery cells were charged and discharged under the following condition.

1^{st} cycle charge and discharge condition
charge: CC (constant current) 0.05 C [cut-off 0.005V]
discharge: CC 0.05 C [cut-off 1.4V]

2^{nd} cycle-100^{th} cycle charge and discharge condition
charge: CC-CV (constant voltage) 0.5 C/0.005V [cut-off 0.1 C]
discharge: CC 0.5 C [cut-off 1.4V]

The efficiency characteristic was evaluated by a ratio of initial discharge capacity relative to initial charge capacity during the charge and discharge. The cycle-life characteristic was evaluated by a ratio of discharge capacity after the 100^{th} cycle relative to initial discharge capacity.

The results are provided in Table 3.

TABLE 3

| | Initial charge | Initial discharge | | Retention |
|---|---|---|---|---|
| | capacity | capacity | Efficiency | ratio |
| | (mAh/g) | (mAh/g) | (%) | (%) |
| Example 1 | 2215 | 1643 | 74.2 | 78.6 |
| Example 2 | 2281 | 1661 | 72.8 | 85.3 |
| Example 3 | 2423 | 1788 | 73.8 | 91.3 |
| Example 4 | 2165 | 1505 | 69.5 | 79.5 |
| Comparative | 1888 | 1399 | 74.1 | 43.1 |
| Example 1 | | | | |
| Comparative | 1917 | 1403 | 73.2 | 55.2 |
| Example 2 | | | | |
| Comparative | 2175 | 1146 | 52.7 | 62.3 |
| Example 3 | | | | |
| Comparative | 1985 | 959 | 48.3 | 49.5 |
| Example 4 | | | | |

Referring to Table 1, the battery cells according to Examples 1 to 4 had excellent initial efficiency and cycle-life characteristics. In contrast, the battery cells according to Comparative Examples 3 and 4 had low initial efficiency and cycle-life characteristics, and the battery cells according to Comparative Examples 1 and 2 had low cycle-life characteristics. Particularly, the battery cells according to Comparative Examples 3 and 4 showed extremely deteriorated battery performances due to the negative active materials with the Raman peak ratio (B/A) of more than 2.5, even though they had low expansion ratio and crack generation ratio, as shown in Table 2.

Based on the results, the lithium secondary battery cells according to Examples 1 to 4 had improved expansion rate, crack generation degrees and simultaneously, improved efficiency, and cycle-life characteristics compared with the lithium secondary battery cells according to Comparative Examples 1 to 4.

While the present embodiments have been described in connection with what is presently considered to be practical exemplary embodiments, it is to be understood that the invention is not limited to the disclosed embodiments and is intended to cover various modifications and equivalent arrangements included within the spirit and scope of the appended claims.

What is claimed is:

1. A negative active material for a lithium secondary battery comprising silicon oxide represented by a chemical formula SiOₓ (1.1<x<1.5).

2. The negative active material of claim 1, wherein the value of x is in a range of about 1.25 to about 1.35.

3. The negative active material of claim 1, wherein the silicon oxide has a first peak in a region ranging from about 150 cm⁻¹ to 200 cm⁻¹ and a second peak in a region ranging from about 450 cm⁻¹ to 500 cm⁻¹ in the Raman spectrography, and
the first and second peaks have a ratio ranging from 1:1.5 to 1:2.5.

4. The negative active material of claim 3, wherein the first peak and second peaks have a ratio ranging from 1:1.8 to 1:2.35.

5. The negative active material of claim 1, wherein the silicon oxide has a cumulative 90% percentage diameter (D90) of about 50 μm or less in the diameter distribution acquired in a laser diffraction scattering diameter distribution method.

6. The negative active material of claim 5, wherein the silicon oxide has a cumulative 90% diameter (D90) ranging from about 0.5 μm to about 40 μm in the diameter distribution acquired in a laser diffraction scattering diameter distribution method.

7. The negative active material of claim 1, which further comprises crystalline silicon.

8. The negative active material of claim 7, wherein the crystalline silicon has a size ranging from about 1 nm to about 800 nm.

9. The negative active material of claim 1, wherein the silicon oxide is amorphous silicon oxide.

10. A negative electrode for a lithium secondary battery comprising:
a current collector, and
an active material layer disposed on the current collector and comprising a negative active material, wherein
the negative active material comprises silicon oxide represented by a chemical formula SiOₓ (1.1<x<1.5).

11. The negative electrode of claim 10, wherein the value of x is in a range of about 1.25 to about 1.35.

12. The negative electrode of claim 10, wherein the silicon oxide has a first peak in a region ranging from about 150 cm⁻¹ to 200 cm⁻¹ and a second peak in a region ranging from 450 cm⁻¹ to 500 cm⁻¹ in a Raman spectrography analysis, and
the first and second peaks have a ratio ranging from about 1:1.5 to about 1:2.5.

13. The negative electrode of claim 12, wherein the first peak and second peaks have a ratio ranging from about 1:1.8 to about 1:2.35.

14. The negative electrode of claim 10, wherein the silicon oxide has a cumulative 90% diameter (D90) of about 50 μm or less in a laser diffraction scattering diameter distribution method.

15. The negative electrode of claim 14, wherein the silicon oxide has a cumulative 90% diameter (D90) ranging from about 0.5 μm to about 40 μm in a laser diffraction scattering diameter distribution method.

16. The negative electrode of claim 10, wherein the negative active material further comprises crystalline silicon.

17. The negative electrode of claim 16, wherein the crystalline silicon has a size ranging from about 1 nm to about 800 nm.

18. The negative active material of claim 10, wherein the silicon oxide is amorphous silicon oxide.

19. A lithium secondary battery comprising the negative electrode of claim 10.

20. The lithium secondary battery of claim 19, further comprising a positive electrode; and a separator, wherein the separator is interposed between the negative electrode and the positive electrode.
